(19) United States
(12) Patent Application Publication
(10) Pub. No.: US 2009/0201136 A1
(43) Pub. Date: Aug. 13, 2009

(54) MERCHANDISE SALES DATA PROCESSING APPARATUS

(75) Inventor: Yuya Itagaki, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/365,351

(22) Filed: Feb. 4, 2009

(30) Foreign Application Priority Data
Feb. 8, 2008 (JP) 2008-029621

(51) Int. Cl. H04Q 5/22

(52) U.S. Cl. 340/10.52; 340/10.51

(57) ABSTRACT

A merchandise sales data processing apparatus including a tag reader section that reads information from a memory of a radio tag processes sales data of merchandise attached with the radio tag based on the information read from the memory of the radio tag. Besides, the apparatus generates a password for restricting access to the memory of the radio tag. Then, the apparatus writes the generated password into the radio tag.

### CROSS-REFERENCE TO RELATED APPLICATIONS

This application is based upon and claims the benefit of priority from the prior Japanese Patent Application No. 2008-029621, filed Feb. 8, 2008, the entire contents of which are incorporated herein by reference.

### TECHNICAL FIELD

The present invention relates to a merchandise sales data processing apparatus, such as a Point Of Sales (POS) terminal, to process merchandise sales data based on information of a radio tag attached to each piece of merchandise.

### BACKGROUND

In recent years, in the field of distribution, attention is paid to a system for identifying an individual by using a radio tag, so-called Radio Frequency Identification (RFID) system.

For example, an anti-shoplifting system or an inventory management system using the RFID system is already put to practical use. Besides, a POS system using a radio tag instead of a barcode is studied for practical use.

In the POS system using the barcode, the barcodes attached to the merchandise must be read one by one by a scanner. On the other hand, in the POS system using the radio tag, data of radio tags attached to plural pieces of merchandise can be collectively read. Accordingly, in the POS system using the radio tag, the labor and time required for checkout can be significantly reduced.

However, when the radio tag is attached to every piece of merchandise, invasion of privacy becomes a problem. A radio tag reader reads the data of the radio tag by radio. The radio tag reader can also read the data of the radio tag in a non-contact manner from a position spaced by a certain distance when the position is within the radio communication range. Thus, anyone having the radio tag reader can easily know the information of an article in a bag of another person. Similarly, the information of clothes, accessories and the like of another person can also be known.

In order to solve the problem as stated above, various techniques are proposed to disable the radio tag attached to the merchandise by the radio tag reader at the time of purchase of the merchandise. However, when the radio tag is disabled at the time of the purchase of the merchandise, returned merchandise cannot be processed.

JP-A-2006-178770 discloses a radio tag in which when a disabling instruction is inputted from the outside, the tag is disabled after a specified period is elapsed.

In the technique of the above publication, returning of merchandise can be processed in a period until the specified period is elapsed from just after the purchase of the merchandise. However, the information of the radio tag attached to the merchandise can be read within the period. Thus, the security is insufficient. Besides, when the specified period is elapsed, the radio tag cannot be used at all.

### SUMMARY

The invention has an object to provide a merchandise sales data processing apparatus in which leakage of information of a radio tag attached to checked-out merchandise is prevented from just after checkout, and the radio tag can be effectively used at any time.

According to an aspect of the invention, a merchandise sales data processing apparatus includes a tag reader section that reads information from a memory of a radio tag detected by radio communication, a data processing section that processes sales data of merchandise attached with the radio tag based on the information read from the memory of the radio tag, a password generation section that generates a password for restricting access to the memory of the radio tag, and a password writing section that writes the password generated by the password generation section by radio communication into the radio tag from which the information is read.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a whole structural view of a first and a second embodiments.

FIG. 2 is a structural view of data stored in a memory of a radio tag used in the first embodiment.

FIG. 3 is a block structural view of a POS terminal in the first embodiment.

FIG. 4 is a data structural view of a read tag table in the first embodiment.

FIG. 5 is a view of an example of a receipt printed and issued in the first embodiment.

FIG. 6 is a flowchart of a merchandise registration process executed by a CPU of the POS terminal in the first embodiment.

FIG. 7 is a flowchart of a registration settlement process executed by the CPU of the POS terminal in the first embodiment.

FIG. 8 is a flowchart showing an operation of an alarming personal computer in the first embodiment.

FIG. 9 is a flowchart of a returned merchandise registration process executed by the CPU of the POS terminal in the first embodiment.

FIG. 10 is a flowchart showing a procedure of a radio tag reading program in the first embodiment.

FIG. 11 is a view of an example of a password input screen displayed on an operator display of the POS terminal in the first embodiment.

FIG. 12 is a structural view of data stored in a memory of a radio tag used in the second embodiment.

FIG. 13 is a flowchart of a merchandise registration process executed by a CPU of a POS terminal in the second embodiment.

FIG. 14 is a flowchart of a registration settlement process executed by the CPU of the POS terminal in the second embodiment.

### DETAILED DESCRIPTION

Hereinafter, an embodiment of the invention will be described with reference to the drawings. In this embodiment, the invention is applied to a store in a form in which a radio tag is attached to each piece of merchandise and the merchandise is sold.

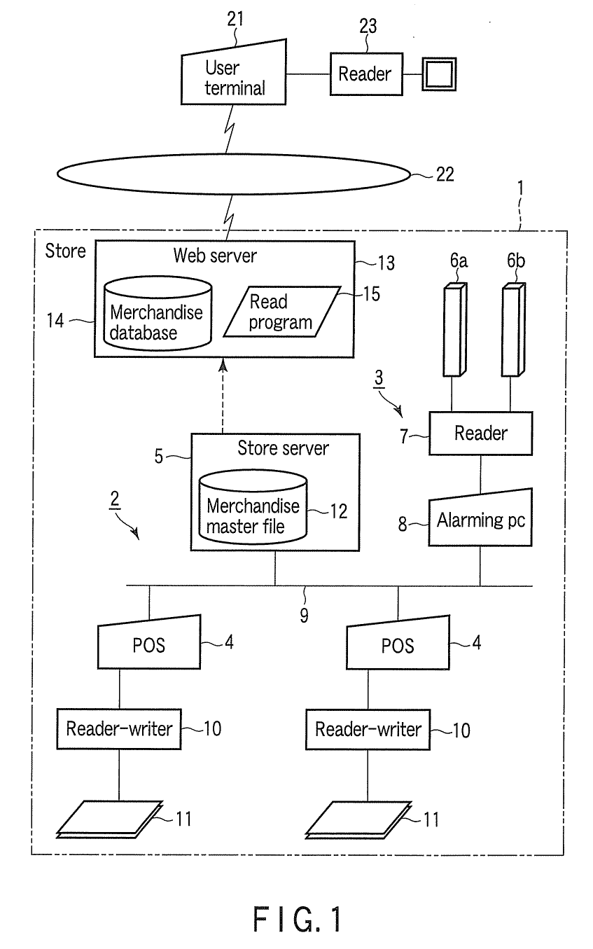

FIG. 1 is a whole structural view of this embodiment. A store 1 includes a POS system 2 and an anti-shoplifting system 3. The POS system 2 includes plural POS terminals 4, and a store server 5 as a host machine thereof. The anti-shoplifting system 3 includes a pair of gate antennas 6a and 6b, a radio tag reader 7, and an alarming personal computer 8. A Local Area Network (LAN) 9 is laid in the store 1. The LAN 9 connects the respective POS terminals 4, the store server 5, and the alarming personal computer 8.

The POS terminal 4 is an example of a merchandise sales data processing apparatus of the invention. Each of the POS terminals 4 is installed on a check-out counter or in the vicinity thereof. The POS terminal 4 is connected to a radio tag reader-writer 10.

The radio tag reader-writer 10 accesses a radio tag existing within the communication range of a planar antenna 11 by using radio communication. The radio tag reader-writer reads data from a memory of the responding radio tag, or writes data in the memory of the radio tag.

The planar antenna 11 is provided on the check-out counter. The planar antenna 11 may be embedded in the check-out counter. Alternatively, it may be provided below the check-out counter.

When merchandise is placed above the planar antenna 11, the radio tag reader-writer 10 reads information of a radio tag attached to the merchandise. The radio tag stores a merchandise ID for identifying the merchandise to which the tag is attached. The radio tag reader-writer 10 transfers the information read from the radio tag to the POS terminal 4. The POS terminal 4 processes the sales data of the merchandise attached with the radio tag based on the information of the radio tag.

The store server 5 collects the merchandise sales data processed by the respective POS terminals 4, and totalizes them. The store server 5 manages the sales of the store, stocks of merchandise, and the like based on the totalized merchandise sales data.

The store server 5 includes a merchandise master file 12. The merchandise master file 12 stores, correspondingly to the merchandise ID of each piece of merchandise, various information relating to the merchandise identified by the merchandise ID. This information includes the name of merchandise, a unit price, a classification code, a classification name, a supplier code, a supplier name and the like. The merchandise ID is generally called an item code, a JAN code, a PLU code or the like.

The pair of gate antennas 6a and 6b are attached to the doorway of the store 1. The radio tag reader 7 accesses the radio tag passing through between the gate antennas 6a and 6b by using the radio communication. The radio tag reader determines the presence or absence of the response from the radio tag. The alarming personal computer 8 always monitors the radio tag reader 7. When detecting the response from the radio tag, the alarming personal computer issues an alarm.

In this embodiment, the radio tag attached to the merchandise available for sale in the store responds to the radio tag reader 7. On the other hand, the radio tag attached to the merchandise checked out by the POS terminal 4 does not respond to the radio tag reader 7. Accordingly, even if the checked-out merchandise is taken out from the store 1, the alarming personal computer 8 does not issue the alarm. However, when the merchandise which is not checked out is taken out from the store 1, the alarming personal computer 8 issues the alarm. Thus, shoplifting can be prevented.

The store 1 installs a Web server 13. The installation place of the Web server 13 may be inside or outside the store 1. The Web server 13 publishes a merchandise database 14 and a radio tag reading program 15 on the Web.

The merchandise database 14 is an aggregate of various information relating to merchandise, such as merchandise IDs of respective pieces of merchandise, merchandise names and unit costs. The Web server 13 creates the merchandise database 14 based on the data of the merchandise master file 12.

An example of a merchandise database creating method will be described below.

The Web server 13 is connected to the store server 5 through the network. The store server 5 downloads the data of the merchandise master file 12 to the Web server 13. The Web server 13 creates the merchandise database 14 based on the downloaded data.

Another example of a merchandise database creating method will be described below.

The store server 5 stores the data of the merchandise master file 12 into a storage medium readable by the Web server 13. The Web server 13 reads the data of this storage medium, and creates the merchandise database 14.

The radio tag reading program 15 is an application program for reading information of the radio tag attached to each piece of merchandise.

The user uses a user terminal 21 and accesses the Web server 13 through the Internet 22, and can browse the merchandise database 14. The user terminal 21 is an information processing apparatus supporting the Internet, such as a personal computer.

Besides, the user can download the radio tag reading program 15 to the user terminal 21. The user terminal 21 to which the radio tag reading program 15 is downloaded can read the information of the radio tag by connecting a radio tag reader 23.

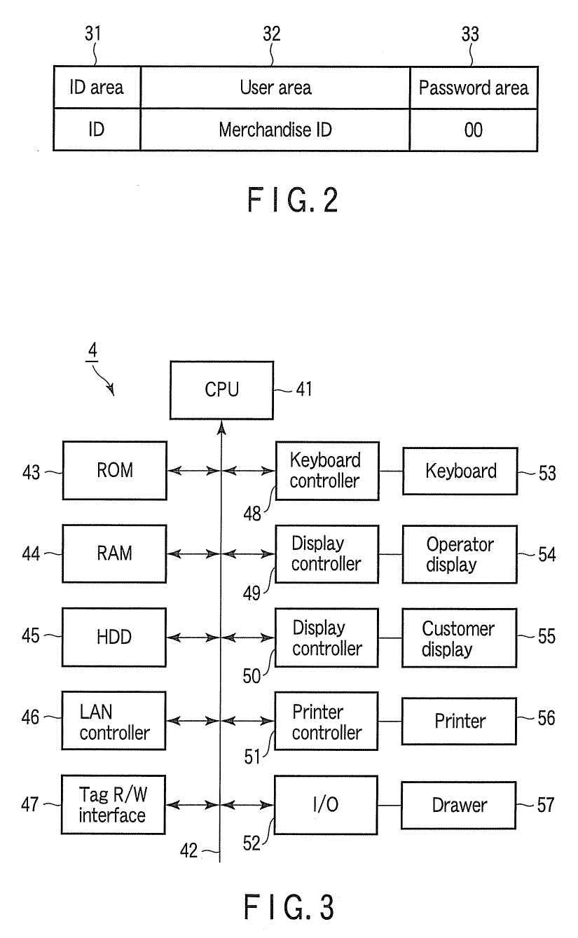

FIG. 2 is a structural view of data stored in the memory of the radio tag attached to the merchandise. The memory of the radio tag is divided into an ID area 31, a user area 32 and a password area 33. The ID area 31 stores a unique ID (called a tag ID) for identifying the radio tag individually. The user area 32 stores the merchandise ID of the merchandise to which the radio tag is attached. The password area 33 stores a password for controlling access to the memory of the radio tag.

The password is a random number generated in the range (01 to FF: hexadecimal) represented by two bytes. It is assumed that when this password is “00”, a password is not yet set. In this embodiment, in the radio tag attached to the merchandise which is not checked out, the password is not yet set. When the merchandise is checked out, the password is set to the radio tag attached to the merchandise by the POS terminal 4.

FIG. 3 is a block diagram of the POS terminal 4. The POS terminal 4 includes a Central Processing Unit (CPU) 41 as a control section main body. The CPU 41 is connected through an address bus and data bus 42 to a Read Only Memory (ROM) 43, a Random Access Memory (RAM) 44, a Hard Disk Drive (HDD) 45, a LAN controller 46, a tag reader-writer interface 47, a keyboard controller 48, a first display controller 49, a second display controller 50, a printer controller 51 and an Input/Output (I/O) port 52.

The ROM 43 stores a fixed program and the like. The RAM 44 stores various variable data. The HDD 45 stores a variable program and various data files. The LAN controller 46 controls transmission and reception of data performed through the LAN 9. The tag reader-writer interface 47 transmits and receives data signals to and from the radio tag reader-writer 10.

The keyboard controller 48 controls a keyboard 53. The first display controller 49 controls an operator display 54. The second display controller 50 controls a customer display 55. The printer controller 51 controls a printer 56 having a receipt printing function. The I/O port 52 outputs a signal to a drawer 57 for storing cash.

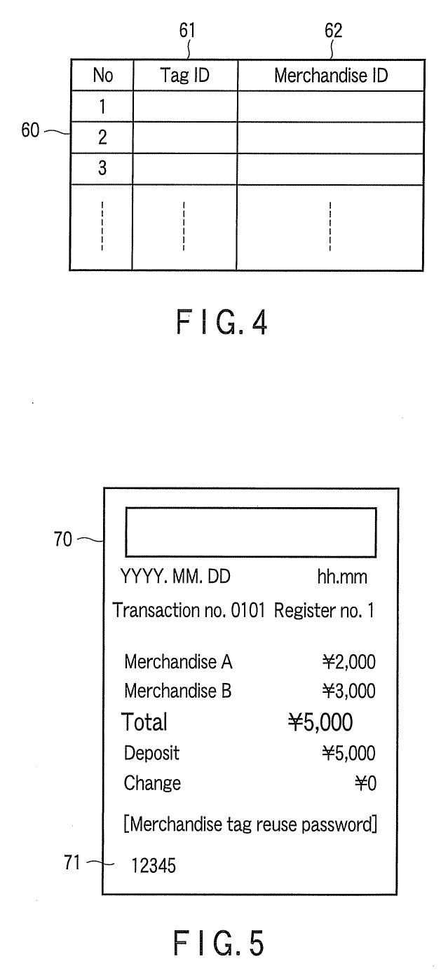

The RAM 44 stores a read tag table 60 as a work area. FIG. 4 shows a data structure of the read tag table 60. The read tag table 60 includes a tag ID area 61 and a merchandise ID area 62 for each of a series of table numbers.

FIG. 5 shows an example of a receipt 70 printed by the printer 56. The receipt 70 has an area for printing a password 71. The password 71 is required when the merchandise tag is reused. The password 71 will be described later.

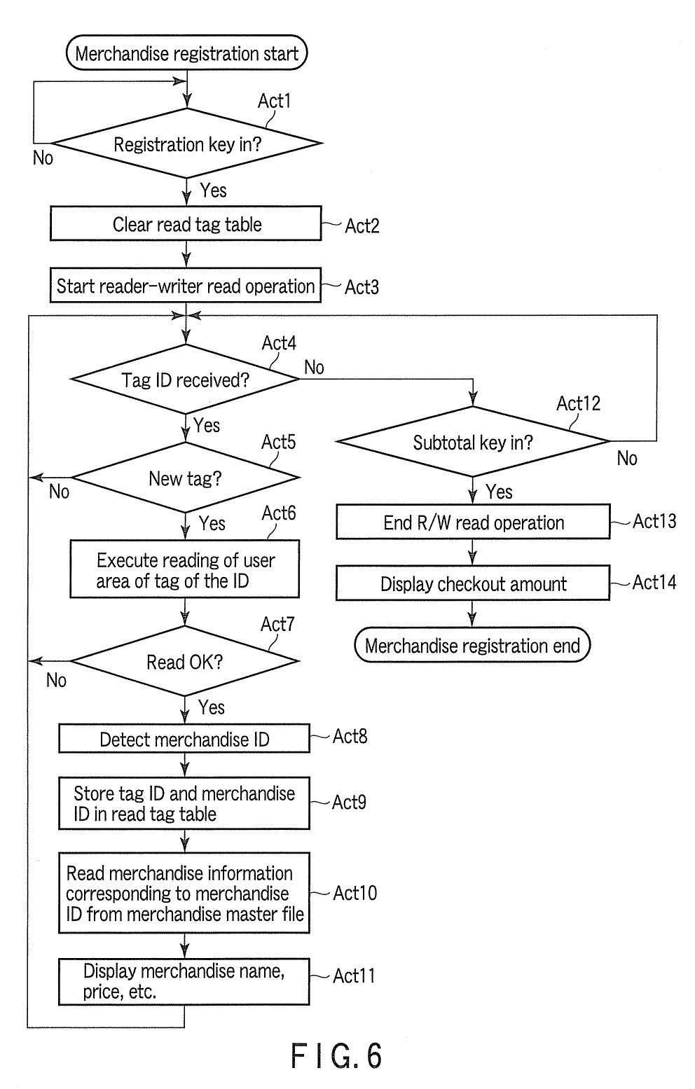

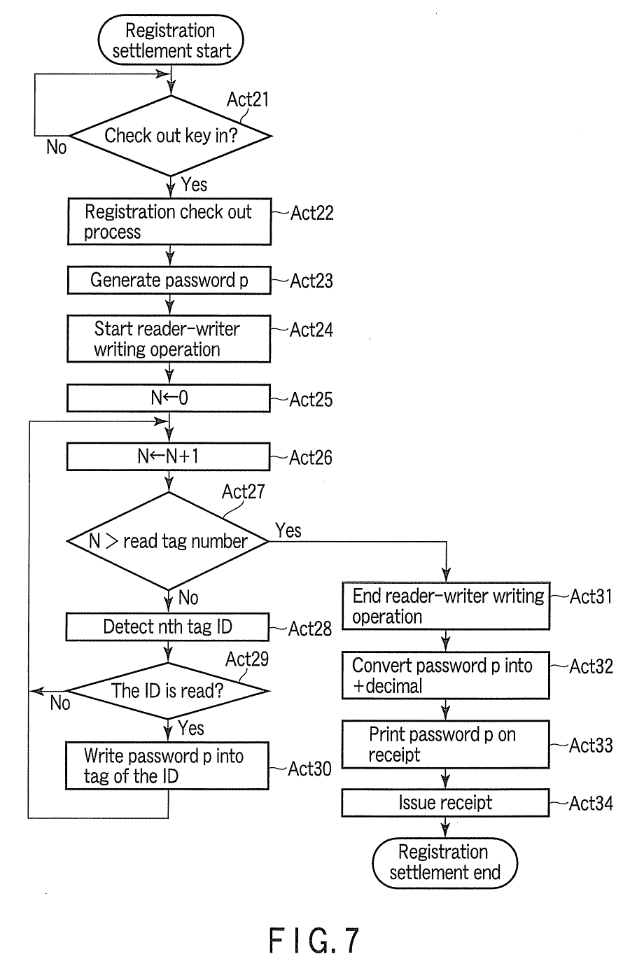

FIG. 6 is a flowchart of a merchandise registration process executed by the CPU 41 of the POS terminal 4. Besides, FIG. 7 is a flowchart of a registration settlement process executed by the CPU 41. Hereinafter, a checkout operation of merchandise purchased by a customer will be described with reference to the flowcharts.

When the checkout operation occurs, the operator of the POS terminal 4 places the merchandise of an checkout object on the planar antenna 11. When there are plural pieces of merchandise, those are collectively placed on the planar antenna 11. Next, the operator depresses a registration key. The registration key is provided on the keyboard 53.

The CPU 41 of the POS terminal 4 in an idle state waits until the registration key is operated at Act 1. When detecting by a signal from the keyboard controller 48 that the registration key is operated (YES at Act 1), the CPU 41 clears the read tag table 60 at Act 2.

Next, the CPU 41 transmits a read start command to the radio tag reader-writer 10 at Act 3. When receiving the command, the radio tag reader-writer 10 radiates an inquiry electric wave to a radio tag from the planar antenna 11. When the radio tag exists within the communication area of the planar antenna 11, the radio tag responds to the inquiry electric wave. The radio tag reader-writer 10 reads the tag ID of the ID area 31 from the responding radio tag. The radio tag reader-writer 10 transmits the tag ID to the POS terminal 4.

After transmitting the read start command, the CPU 41 waits for the tag ID at Act 4. When receiving the tag ID through the tag reader-writer interface 47 (YES at Act 4), the CPU 41 determines whether the tag ID is a new tag ID at Act 5. When the tag ID is stored in the read tag table 60, the CPU 41 determines that it is not the new tag (NO at Act 5). When determining that the tag is not the new tag, the CPU 41 returns to the process of Act 4 in order to wait for a next tag ID.

When the tag ID is not stored in the read tag table 60, the CPU 41 determines that the tag ID is the new tag ID (YES at Act 5). When determining that the tag ID is the new tag ID, the CPU 41 transmits a user area read command to the radio tag reader-writer 10 at Act 6. The user area read command does not specify a password.

When receiving the user area read command, the radio tag reader-writer 10 performs radio communication with the radio tag identified by the new tag ID. As a result of the radio communication, when a password is not yet set in the password area 33 of the radio tag, that is, when it is “00”, the radio tag reader-writer 10 reads data stored in the user area 32 of the radio tag.

After transmitting the user area read command, the CPU 41 waits for the data of the user area 32 at Act 7. When receiving the data of the user area 32 through the tag reader-writer interface 47 (YES at Act 7), the CPU 41 detects the merchandise ID from the received data at Act 8.

When detecting the merchandise ID, the CPU 41 correlates the merchandise ID with the new tag ID at Act 9, and stores them in the read tag table 60. Besides, the CPU 41 uses the merchandise ID to retrieve the merchandise master file 12 at Act 10, and reads the merchandise information stored correspondingly to the merchandise ID. The CPU 41 detects a merchandise name, price and the like from the merchandise information at Act 11. The CPU 41 causes the operator display 54 and the customer display 55 to display the detected merchandise name, price and the like.

Thereafter, the CPU 41 returns to the process of Act 4 in order to wait for a next tag ID. Incidentally, also when the data of the user area 32 cannot be received even when a specific time elapses after the user area read command is transmitted (NO at Act 7), the CPU 41 returns to the process of Act 4.

In the radio tag attached to the merchandise of the checkout object, a password is not yet set. Accordingly, when the operator of the POS terminal 2 depresses the registration key in the state where the merchandise of the checkout object is placed on the planar antenna 11, the radio tag reader-writer 10 reads the information in the user area 32, that is, the merchandise ID. The POS terminal 4 processes the merchandise sales data based on the merchandise ID. Besides, the POS terminal 4 stores the tag ID of the radio tag and the merchandise ID into the read tag table 60.

At this time, when plural pieces of merchandise of checkout objects are placed on the planar antenna 11, the radio tag reader-writer 10 sequentially reads the information of the radio tag attached to each of them. The POS terminal 4 sequentially stores the respective tag IDs and the respective merchandise IDs into the read tag table 60. Besides, the POS terminal 4 causes the operator display 54 and the customer display 55 to display the merchandise name, price and the like of the merchandise information corresponding to the merchandise ID.

The operator determines from the display content of the operator display 54 whether all information of the radio tag attached to the merchandise of the checkout object is read. When all information is read, the operator depresses a subtotal key. The subtotal key is provided on the keyboard 53.

The CPU 41 of the POS terminal 4 in the tag ID reception waiting state determines whether the subtotal key is operated at Act 12. When detecting from the signal from the keyboard controller 48 that the subtotal key is operated (YES of Act 12), the CPU 41 transmits a read stop command to the radio tag reader-writer 10 at Act 13. When receiving this command, the radio tag reader-writer 10 stops the radiation of the tag inquiry electric wave.

When transmitting the read stop command, the CPU 41 calculates the checkout amount of the checkout object merchandise at Act 14. The CPU 41 causes the operator display 54 and the customer display 55 to display this checkout amount.

The operator receives the payment of the checkout amount from the customer. When receiving the payment, the operator depresses a check out key. The check out key is provided on the keyboard 53.

The POS terminal 4 finishing the merchandise registration process shifts to a registration settlement process. That is, the CPU 41 waits until the check out key is operated at Act 21. When detecting from the signal from the keyboard controller 48 that the check out key is operated (YES at Act 21), the CPU 41 executes the registration check out process at Act 22. This process includes calculation of change, renewal of sales data, printing of a receipt, recording of a journal, and the like.

When the registration check out process is ended, the CPU 41 generates a random number of two bytes at Act 23. The random number is made a password p for restricting the access to the memory of the radio tag (password generation unit).

After generating the password p, the CPU 41 transmits a write start command to the radio tag reader-writer 10 at Act 24. When receiving this command, the radio tag reader-writer 10 radiates an inquiry electric wave from the planar antenna 11 to the radio tag. At this time, when the radio tag exists within the communication area of the planar antenna 11, the radio tag responds to the inquiry electric wave. The radio tag reader-writer 10 reads the tag ID of the ID area 31 from the responding radio tag. The radio tag reader-writer 10 transmits the tag ID to the POS terminal 4.

After transmitting the write start command, the CPU 41 clears the table number counter N to “0” at Act 25. The table number counter N is stored in, for example, the RAM 44. The CPU 41 counts up the table number counter N by “1” at Act 26. The CPU 41 determines at Act 27 whether the table number counter N exceeds the number of radio tags read at this merchandise registration process, the so-called read tag number.

When the table number counter N does not exceed the read tag number (NO at Act 27), the CPU 41 detects the tag ID stored in the table number N of the read tag table 60 at Act 28. The CPU 41 waits until the radio tag reader-writer 10 reads the tag ID at Act 29.

When the tag ID is read by the radio tag reader-writer 10, the CPU 41 transmits a password write command to the radio tag reader-writer 10 at Act 30. This command includes the password p generated by the process of Act 23. When receiving the command, the radio tag reader-writer 10 performs radio communication with the radio tag identified by the tag ID. The password p is written in the password area 33 of the radio tag (password writing unit).

After transmitting the password write command, the CPU 41 returns to the process of Act 26 in order to further count up the table number counter N by “1”. When counting up the table number counter N, the CPU 41 detects the tag ID stored in the table number N of the read tag table 60 (Act 28). When the tag ID is read (YES at Act 29), the CPU 41 transmits the password write command to the radio tag reader-writer 10 (Act 30). Hereinafter, the CPU 41 repeatedly executes the process of from Act 26 to Act 30 until the table number counter N exceeds the read tag number.

Accordingly, the radio tag reader-writer 10 writes the same password p into the password area of each radio tag whose tag ID is stored in the read tag table 60.

When the table number counter N exceeds the read tag number (YES at Act 27), the CPU 41 transmits a write stop command to the radio tag reader-writer 10 at Act 31. When receiving this command, the radio tag reader-writer 10 stops the radiation of the tag inquiry electric wave.

After transmitting the write stop command, the CPU 41 converts the password p into decimal number at Act 32. The CPU 41 causes the decimal number password p to be a merchandise tag reuse password 71. The CPU 41 controls the printer 56 to print the merchandise tag reuse password 71 on the receipt 70 at Act 33. That is, the CPU 41 outputs the password p written in the radio tag in a form in which a purchaser of the merchandise to which the radio tag is attached can recognize (password output unit). Thereafter, the CPU 41 issues the receipt 70 at Act 34.

The operator delivers the receipt 70 issued from the POS terminal 4 to the customer. The customer who receives the receipt goes out of the store while having the checked-out merchandise. In the radio tag attached to the merchandise, the same password p is written in the password area 33 of the memory. The radio tag in which the password p is written does not respond to the user area read command unless the password is specified.

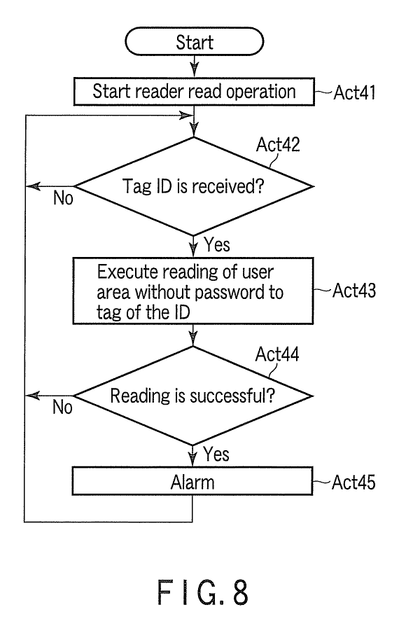

The alarming personal computer 8 operates in a procedure shown in a flowchart of FIG. 8. That is, after start-up of the system, the alarming personal computer 8 transmits a read start command to the radio tag reader 7 at Act 41. When receiving this command, the radio tag reader 710 radiates an inquiry electric wave from the gate antennas 6a and 6b to the radio tag. When the radio tag passes through between the gate antennas 6a and 6b, the radio tag responds to the inquiry electric wave. The radio tag reader 7 reads the tag ID stored in the ID area 31 of the responding radio tag. The radio tag reader 7 transmits the tag ID to the alarming personal computer 8.

After transmitting the read start command, the alarming personal computer 8 waits for the tag ID at Act 42. When receiving the tag ID through the radio tag reader 7 (YES at Act 42), the alarming personal computer 8 transmits a user area read command to the radio tag reader-writer 10 at Act 43. The user area read command does not specify a password.

After transmitting the user area read command, the alarming personal computer 8 waits for the data of the user area 32 at Act 44. When the data of the user area 32 cannot be read (NO at Act 44), the alarming personal computer 8 returns to the process of Act 42 in order to detect a next tag ID.

When the data of the user area 32 can be read (YES at Act 44), the alarming personal computer 8 issues an alarm at Act 45. For example, an alarm sound is issued. Alternatively, an alarm lamp is lighted. Thereafter, return is made to the process of Act 42 in order to wait for the next tag ID.

As stated above, the password p is written in the radio tag of the checked-out merchandise. Accordingly, when the customer has the checked-out merchandise and goes out of the store, an alarm is not issued. However, the password is not set in the radio tag attached to the merchandise which is not yet checked out. Thus, when the customer has the merchandise which is not yet checked out and goes out of the store, an alarm is issued. That is, the anti-shoplifting system effectively functions.

The radio tag remains attached to the checked-out merchandise. However, in order to read the information of the user area 32 of the radio tag by the radio tag reader, it is necessary to know the password p set in the password area 33. In other words, unless the password p is known, the information of the user area 32 of the radio tag attached to the merchandise is not illegally read from just after the purchase of the merchandise. The password p is printed on the receipt 70. However, as long as the receipt 70 is not seen, the password is not known to another person. Accordingly, the risk of information leakage that causes an invasion of personal privacy from the information of the radio tag attached to the merchandise is very low.

In the store, there is a case where a customer wants to return the checked-out merchandise. At that time, it is necessary to confirm whether the merchandise was truly purchased at the store. Even if the purchase history of the returned object merchandise is recorded on the receipt, it is not certain whether the returned merchandise itself is the merchandise printed on the receipt. The POS terminal 4 can deal with the return service as stated above.

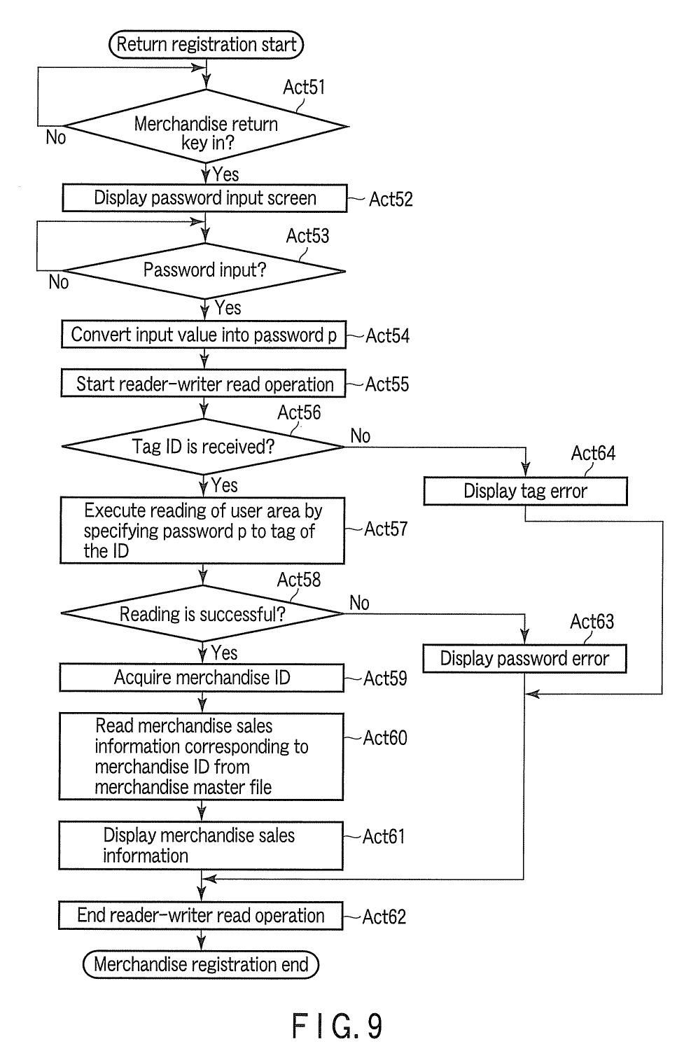

FIG. 9 is a flowchart of a return registration process executed by the CPU 41 of the POS terminal 4. Hereinafter, the return service of a piece of merchandise will be described with reference to the flowchart.

When the return service occurs, the operator of the POS terminal 4 first places a piece of merchandise of a return object above the planar antenna 11. Besides, the operator requests the customer to exhibit the receipt 70 issued when the return object merchandise was purchased. Thereafter, the operator depresses a merchandise return key. The merchandise return key is provided on the keyboard 53.

The CPU 41 of the POS terminal 4 in an idle state waits until the merchandise return key is operated at Act 51. When the merchandise return key is operated (YES at Act 51), the CPU 41 causes the operator display 54 to display a password input screen 80 at Act 52 (password reception unit).

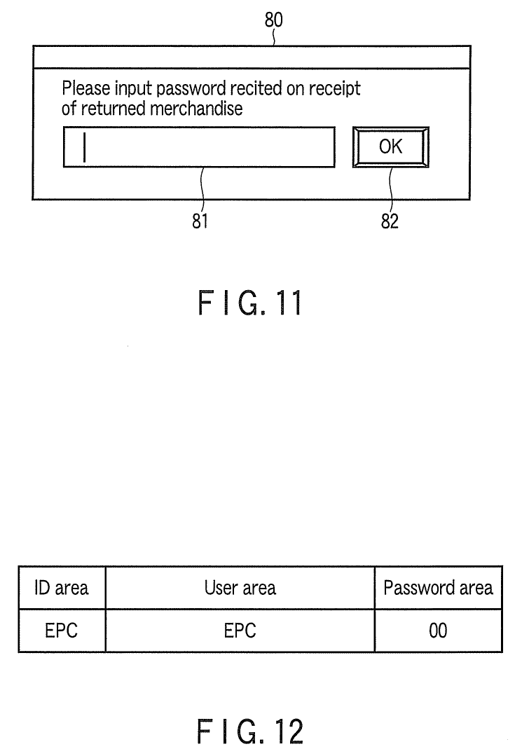

FIG. 11 shows an example of the password input screen 80. As shown in the drawing, the password input screen 80 includes an input column 81 of a password and an OK button 82.

The operator operates the keyboard 53 to input the merchandise tag reuse password 71 printed on the receipt 70 exhibited by the customer into the input column 81. Further, the operator inputs the OK button 82.

After displaying the password input screen 80, the CPU 41 waits for the input of the merchandise tag reuse password 71 at Act 53. When the password 71 is inputted, the CPU 41 converts the password 71 into a password p in hexadecimal at Act 54.

The CPU 41 transmits a read start command to the radio tag reader-writer 10 at Act 55. When receiving the read start command, the radio tag reader-writer 10 radiates a tag inquiry electric wave from the planar antenna 11 to the radio tag. At this time, when the radio tag exists within the communication area of the planar antenna 11, the radio tag responds to the inquiry electric wave. The radio tag reader-writer 10 reads the tag ID stored in the ID area 31 of the responding radio tag, and notifies it to the POS terminal 4.

After transmitting the read start command, the CPU 41 waits for the tag ID at Act 56. When receiving the tag ID through the tag reader-writer interface 47 (YES at Act 56), the CPU 41 transmits a user area read command to the radio tag reader-writer 10 at Act 57. The user area read command specifies the password p (tag information read unit).

When receiving the user area read command, the radio tag reader-writer 10 performs radio communication with the radio tag identified by the tag ID. At this time, when the password p is set in the password area 33 of the radio tag, the radio tag reader-writer 10 reads the data stored in the user area 32.

After transmitting the user area read command, the CPU 41 waits for the data of the user area 32 at Act 58. When receiving the data of the user area 32 (YES at Act 58), the CPU 41 detects the merchandise ID from the data at Act 59.

The CPU 41 retrieves the merchandise master file 12 in order to read the merchandise information stored correspondingly to the merchandise ID at Act 60. When reading the merchandise information from the merchandise master file 12, the CPU 41 detects the merchandise name, price and the like from this merchandise information at Act 61. The CPU 41 causes the operator display 54 and the customer display 55 to display the merchandise name, price and the like.

Thereafter, the CPU 41 transmits a read stop command to the radio tag reader-writer 10 at Act 62. By this, the radio tag reader-writer 10 stops the radiation of the tag inquiry electric wave.

On the other hand, when the data of the user area 32 cannot be detected in response to the transmission of the user area read command in which the password p is specified (NO at Act 58), the CPU 41 causes the operator display 54 to display a message of password error at Act 63.

Besides, when the tag ID cannot be detected in response to the transmission of the read start command (NO at Act 56), the CPU 41 causes the operator display 54 to display a message of tag error at Act 64. After displaying these error messages, the CPU 41 transmits a read stop command to the radio tag reader-writer 10.

Accordingly, when the merchandise name and price of the return object merchandise are displayed, it can be decided that the merchandise is the merchandise sold at the store itself. On the other hand, when the password error or the tag error is displayed, it cannot be decided whether the merchandise was sold at the store itself. In this case, confirmation is performed by another method.

Besides, in this embodiment, the merchandise is provided to the customer in the state where the radio tag is attached. It is preferable that the customer can effectively use the information of the radio tag. In this embodiment, the radio tag reading program 15 for reading the information of the radio tag is delivered from the Web server 13 of the store.

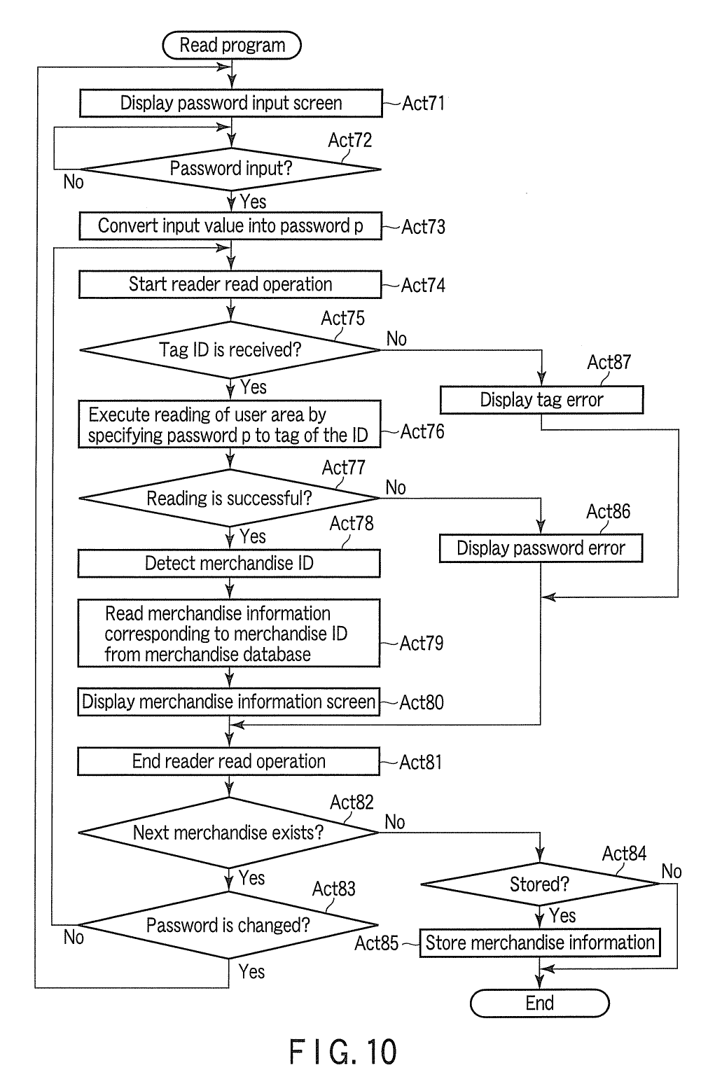

The CPU of the user terminal 21 in which the radio tag reading program 15 is installed operates in a procedure shown in the flowchart of FIG. 10 by the start of the program 15.

First, the CPU displays a password input screen on the display of the user terminal 21 at Act 71. Then, the CPU waits for the input of a password at Act 72. Here, when a value corresponding to the merchandise tag reuse password 71 is inputted from the password input screen, the CPU converts the inputted value into a password p in hexadecimal at Act 73.

The CPU transmits a read start command to the radio tag reader 23 at Act 74. When receiving this command, the radio tag reader 23 causes the antenna to radiate a tag inquiry electric wave. At this time, when the radio tag exists within the communication range of the antenna, the radio tag responds to the inquiry electric wave. The radio tag reader 23 reads the tag ID stored in the ID area 31 of the responding radio tag. The radio tag reader 23 transmits the tag ID to the user terminal 21.

After transmitting the read start command, the CPU waits for the tag ID at Act 75. When receiving the tag ID read by the radio tag reader 23 (YES at Act 75), the CPU of the user terminal 21 transmits a user area read command to the radio tag reader 23 at Act 76. The user area read command specifies the password p.

When receiving this command, the radio tag reader 23 performs radio communication with the radio tag identified by the tag ID. At this time, when the password p is set in the password area 33 of the radio tag, the data stored in the user area 32 is read by the radio tag reader 23.

After transmitting the user area read command, the CPU waits for the data of the user area 32 at Act 77. Then, when receiving the data of the user area 32 read by the radio tag reader 23 (YES at Act 77), the CPU 41 detects the merchandise ID from the data at Act 78.

The CPU accesses the Web server 13 through the Internet 22 at Act 79. The CPU reads the merchandise information stored correspondingly to the merchandise ID from the merchandise database 14 published by the Web server 13. The CPU causes the display of the user terminal 21 to display the merchandise information by using a browser at Act 80.

The CPU transmits a read stop command to the radio tag reader 23 at Act 81. When receiving this command, the radio tag reader 23 stops the radiation of the inquiry electric wave.

After transmitting the read stop command, the CPU determines whether a process to next merchandise is selected at Act 82. When the process is selected (YES at Act 82), the CPU determines whether a password is changed at Act 83. When the password is not changed (NO at Act 83), the CPU returns to the process of Act 74 in order to transmit the read start command again to the radio tag reader 23.

When the password is changed, return is made to the process of Act 71 in order to display the password input screen on the display. When the value corresponding to the merchandise tag reuse password 71 is inputted from the password input screen, the CPU converts it into a password p in hexadecimal. The CPU transmits the read start command again to the radio tag reader 23.

When the process to the next merchandise is not selected (NO at Act 82), the CPU determines whether a storage process is selected at Act 84 (Act 84). When the storage process is selected (YES at Act 84), the CPU stores the merchandise information acquired from the merchandise database 14 into the storage section of the user terminal 21 at Act 84. The read program is ended with the above process.

When the end of the program is selected while neither the process to the next merchandise nor the storage process is selected (NO at Act 84), the CPU does not store the merchandise information. The merchandise information acquired from the merchandise database 14 is discarded.

Incidentally, when the data of the user area 32 cannot be detected in response to the transmission of the user area read command in which the password p is specified (NO at Act 77), the CPU causes the display of the user terminal 21 to display a message of password error at Act 86.

Besides, when the tag ID cannot be detected in response to the transmission of the read start command (NO at Act 75), the CPU causes the display of the user terminal 21 to display a message of tag error at Act 87. When the error message is displayed, the CPU transmits a read stop command to the radio tag reader 23.

Accordingly, the customer who wants to use the information of the radio tag attached to the purchased merchandise operates the user terminal 21, and downloads the read program 15 from the Web site of the store 1. Besides, the commercially available radio tag reader 23 is connected to the user terminal 21. Then, the read program 15 is started.

When the read program 15 is started in the user terminal 21, the password input screen 80 is displayed on the display of the user terminal 21. The customer inputs the merchandise tag reuse password 71 printed on the receipt 70 issued when the desired merchandise was purchased. In general, the password set in the radio tag attached to the merchandise is coincident with the password converted from the inputted merchandise tag reuse password 71.

When the passwords are coincident with each other, the radio tag reader 23 reads the merchandise ID stored in the user area 32 of the radio tag. When the merchandise ID is read, the radio tag reader 23 accesses the Web server 13. The merchandise information corresponding to the merchandise ID is downloaded from the merchandise database 14. The radio tag reader 23 displays the downloaded merchandise information on the display.

When the operator wants to use the information of the radio tag attached to another merchandise, the operator selects the process to the next merchandise. Here, when the receipt is different from that of the just previous merchandise, password change is specified. When the receipt is the same as that of the just previous merchandise, the password change is not specified. When the password change is specified, the password input screen 80 is displayed on the display of the user terminal 21. The operator inputs the merchandise tag reuse password 71 of the corresponding receipt.

The customer uses the radio tag attached to the merchandise, and can download various information of the merchandise from the merchandise database 14 to the user terminal 21. The downloaded merchandise information is used for, for example, the preparation of household accounts.

In recent years, the radio tag is standardized internationally, and a code for commodity management, which is global and completely unique, so-called Electric Product Code (EPC) is proposed. Then, next, another embodiment in which a radio tag attached to each piece of merchandise is an EPC type will be described.

Incidentally, for convenience of explanation, the embodiment described with reference to FIG. 1 to FIG. 11 is called a first embodiment, and the embodiment described below is called a second embodiment. The second embodiment is also applied to a store 1 similar to that of the first embodiment. The same portions as those of the first embodiment are denoted by the same reference numerals and their detailed description will be omitted.

FIG. 12 is a structural view of data stored in a memory of a radio tag in the EPC type. Similarly to the first embodiment, the memory of the radio tag is divided into an ID area 31, a user area 32 and a password area 33. However, the ID area 31 and the user area 32 store the same EPC. A merchandise master file 12 stores various information relating to the merchandise correspondingly to the EPC of each radio tag. The same applies to a merchandise database 14.

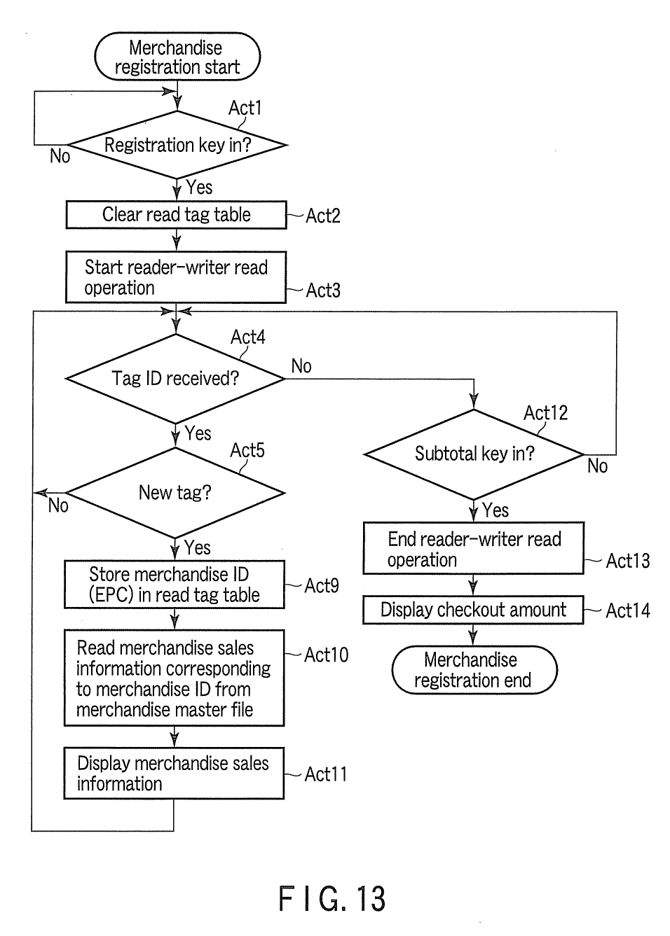

FIG. 13 is a flowchart of a merchandise registration process executed by a CPU 41 of a POS terminal 4. The point different from the first embodiment is a process after the determination process of Act 5. In the case of the radio tag of the EPC type, the tag ID is the EPC, and is the same as the information of the user area 32. When it is determined that the tag ID of the radio tag detected by the radio tag reader-writer 10 is a new tag ID, the CPU 41 stores this tag ID (EPC) into the read tag table 60 (Act 9).

As stated above, when the radio tag of the EPC type is used, the user area read process of Act 6 to Act 8 can be omitted.

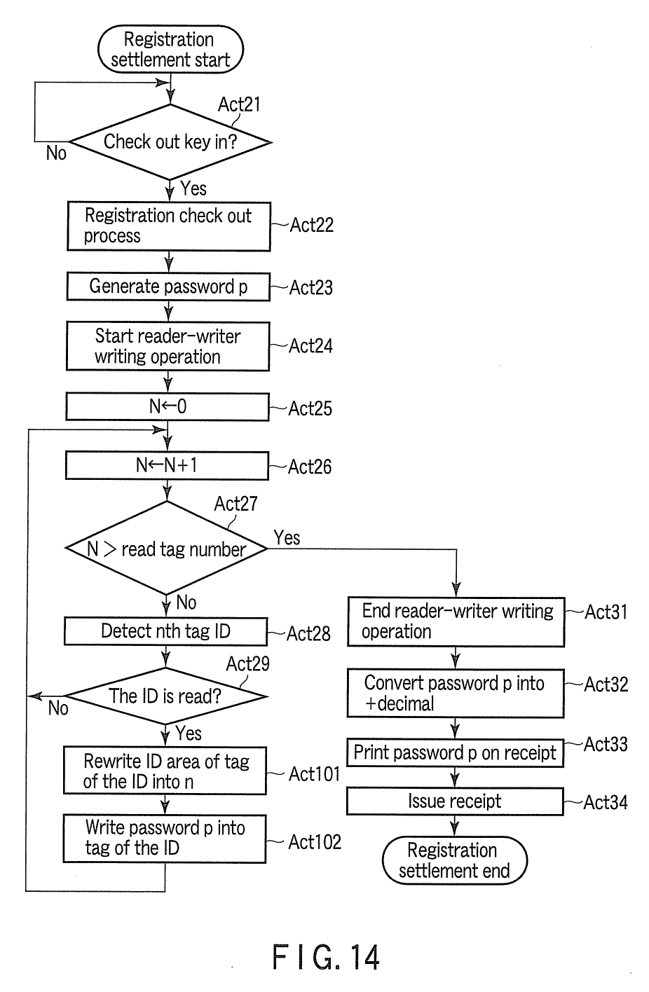

FIG. 14 is a flowchart of a registration settlement process executed by the CPU 41 of the POS terminal 4. The point different from the first embodiment is a process after the process of Act 29. In the case of the radio tag of the EPC type, the information of the ID area 31 and the information of the user area 32 are the same (EPC). On the other hand, when a password is set in the password area 33, the information of the user area 32 cannot be read unless the password is specified. However, the information of the ID area 31 can be read even when the password is not specified. Thus, even if the password is set in the password area 33, the information (EPC) of the user area 32 can be known.

Then, in this embodiment, when the tag ID (EPC) acquired from the table number N of the read tag table 60 is read by the radio tag reader-writer 10 (YES at Act 29), the CPU 41 transmits an ID rewriting command for the radio tag identified by the tag ID to the radio tag reader-writer 10 at Act 101. This command includes a value N of the table number counter acquired by the process of Act 26. When receiving this command, the radio tag reader-writer 10 performs radio communication with the radio tag identified by the tag ID. The information of the ID area 31 is rewritten from the EPC to the count value N (code rewriting unit).

The CPU 41 waits until the tag ID coincident with the count value N is read by the radio tag reader-writer 10 at Act 102. When the tag ID is read by the radio tag reader-writer 10, the CPU 41 transmits a password write command to the radio tag reader-writer 10. The command includes the password p generated by the process of Act 23. When receiving this command, the radio tag reader-writer 10 performs radio communication with the radio tag identified by the tag ID. Then, the password p is written in the password area 33 (password writing unit).

As stated above, when the password is written in the radio tag, simultaneously with the writing, the tag ID is converted from the EPC into the value N of the table number counter. In the radio tag in which the tag ID is converted from the EPC into the value N, the tag ID, that is, the value N is read by the radio tag reader. However, as long as the password set in the password area 33 is not specified, the information stored in the user area 32, that is, the EPC is not read. Accordingly, the risk of information leakage that causes an invasion of personal privacy from the information of the radio tag attached to the merchandise is very low.

Incidentally, since the tag ID is converted from the EPC into the value N of the table number counter, the return registration process of the POS terminal 4 is the same as the first embodiment. Besides, the radio tag reading program 15 of the first embodiment can be used as it is. Further, the anti-shoplifting system 3 of the first embodiment may be adopted as it is.

Incidentally, the invention is not limited to the embodiments as described above, but can be embodied at the practical stage by modifying the components within the scope not departing from the gist of the invention.

For example, in the embodiment, the password written in the radio tag is printed on the receipt 70 issued for the purchaser of the merchandise to which the radio tag is attached. However, the method of output in the format by which the purchaser can recognize is not limited to this. For example, an interface for short-distance radio communication is provided in the POS terminal 4. The password is transferred to a memory of a cellular phone having a short-distance radio communication function and the purchaser can visually recognize it through the display of the cellular phone.

Besides, an Email address linked to a membership number of a member card, a point card or the like is registered in the store server 5. At the time of settlement, the membership number of the card is read by the POS terminal 4. By doing so, the password can be notified to the Email address corresponding to the membership number of the card. Also in this case, the user can visually recognize the password through the display of the personal computer or the cellular phone.

Besides, in the embodiment, although the password is the random number, the password is not limited to this. For example, a unique password is generated by using a transaction number managed by the POS terminal 4, date and time, or the like, and can be set in the radio tag.

Besides, the application of the invention is not limited to the store selling merchandise. For example, the invention is effectively applied to rental shops of books, CDs, DVDs and the like. Incidentally, in these stores, a process step is added in which when the merchandise is returned, the data of the password area 33 is rewritten from an arbitrary password to “00” indicating that a password is not yet set. By doing so, the radio tag added to each piece of merchandise can be used many times.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A merchandise sales data processing apparatus comprising:
a tag reader section that reads information from a memory of a radio tag detected by radio communication;
a data processing section that processes sales data of merchandise attached with the radio tag based on the information read from the memory of the radio tag;
a password generation section that generates a password for restricting access to the memory of the radio tag; and
a password writing section that writes the password generated by the password generation section by radio communication into the radio tag from which the information is read.

2. The apparatus according to claim 1, further comprising a password output section that outputs the password written into the radio tag in a form by which a purchaser of the merchandise to which the radio tag is attached can recognize.

3. The apparatus according to claim 2, wherein the password output section prints and outputs the password on a receipt on which details of the merchandise sales data are printed.

4. The apparatus according to claim 1, further comprising:
a password reception section that receives input of a password; and
a tag information read section that specifies the password received by the password reception section to the radio tag detected by radio communication and instructs reading of memory information.

5. The apparatus according to claim 4, wherein the password reception section is effective when a merchandise return mode is selected.

6. The apparatus according to claim 1, wherein the tag reader section reads the data from the radio tag in which an ID for individual identification stored in the memory and an ID for identifying the merchandise to which the tag is attached are common.

7. The apparatus according to claim 6, further comprising a code rewriting section that rewrites the ID for individual identification in the radio tag detected by the radio communication into a unique code, wherein
the password writing section identifies the radio tag individually by the code rewritten by the code rewriting section, and writes the password into the identified radio tag.

8. The apparatus according to claim 7, wherein the password writing section writes a password for restricting reading of the ID, which is stored in the memory of the radio tag and is for identifying the merchandise, into the radio tag.

9. A merchandise sales data processing method, comprising:
reading, by a tag reader section, information from a memory of a radio tag detected by radio communication;
processing, by a data processing section, sales data of merchandise attached with the radio tag based on the information read from the memory of the radio tag;
generating, by a password generation section, a password for restricting access to the memory of the radio tag; and
writing the password generated by the password generation section by radio communication into the radio tag from which the information is read.

10. The method according to claim 9, wherein the password written into the radio tag is outputted in a form in which a purchaser of the merchandise to which the radio tag is attached can recognize.

11. The method according to claim 10, wherein the password is printed and outputted on a receipt on which details of the merchandise sales data are printed.

12. The method according to claim 9, wherein
input of a password is received by a password reception section, and
the password received by the password reception section is specified to the radio tag detected by radio communication and reading of memory information is instructed.

13. The method according to claim 12, wherein the password reception section is effective when a merchandise return mode is selected.
